(19) United States
(12) Patent Application Publication
(10) Pub. No.: US 2022/0331999 A1
(43) Pub. Date: Oct. 20, 2022

(54) MULTIPURPOSE TOOL

(71) Applicant: LEATHERMAN TOOL GROUP, INC., Portland, OR (US)

(72) Inventor: Andro PURNOMOHADI, Vancouver, WA (US)

(21) Appl. No.: 17/233,930

(22) Filed: Apr. 19, 2021

(51) Int. Cl. B26B 11/00; A01G 3/08; A01G 3/02

(52) U.S. Cl. CPC B26B 11/005; A01G 3/083; A01G 3/02

(57) ABSTRACT

A multipurpose tool, such as a pruning shear that incorporates a pruning saw into a single handheld tool. The pruning shear includes pruning handles with a folding saw blade that pivotally deploys from a stowed position within one of the pruning handles to an extended operational position.

### FIELD OF THE INVENTION

An example embodiment of the current invention relates generally to a multipurpose tool, and more particularly to a hand tool for pruning trees, shrubs, and other plants that includes both a pruning shear and a folding saw.

### BACKGROUND OF THE INVENTION

Pruning shears are handheld tools commonly used in the pruning and shaping of plants and trees, utilizing two sharpened blades that bypass each other in a scissors type motion, or an anvil and blade, where the blade cuts through the plant and contacts the anvil much like a knife against a cutting board. Both bypass and anvil pruners utilize a pivot axis with the blades extending from one side of the pivot axis and handles extending from the other side of the pivot axis. Generally, pruning shears are effective for cutting plant stems and branches up to about one inch in diameter while minimizing damage to the plant. However, when attempting to cut branches with diameters larger than approximately one inch, pruning shears can begin to add additional damage to the plant stem or branch being cut, thereby adding additional stress to the plant and increasing the potential for disease to be introduced to the plant. Pruning saws are tools used to cut and remove stems and branches of plants that are too large in diameter to effectively be removed by pruning shears.

Current pruning practice often requires the use of both pruning shears and a pruning saw, and when pruning large shrubs, bushes, and trees also requires the use of a ladder. This requires the person performing the pruning to continuously switch between tools, and to utilize some sort of carrying mechanism to hold the tool that is not in use.

To address these drawbacks, pruning shears have been designed to incorporate a folding saw into one of the handles of the pruning shears, wherein the saw is stowed within the handle when not in use, and is rotated around an axis in the handle to an extended position when deployed for use. Current pruning shears incorporating a rotatable saw have the disadvantage, however, of having the length of the saw limited to the length of the pruning handle housing it. A relatively short saw requires the user to make many short strokes to saw through the branch or stem being cut, thus increasing operator effort. In order to get a longer saw, one must make the handle longer, which reduces ergonomics and increases weight of the tool.

### SUMMARY OF THE INVENTION

The pruning tool of this invention incorporates the functions of a pruning shear and a pruning saw into a single tool, thus allowing the user to quickly and efficiently transition between the pruning shears and the pruning saw. The pruning tool takes the form of a pruning shear that incorporates a folding saw blade into one handle of the shear. The saw blade is rotationally deployed from a stowed position within the handle to an extended operational position in which the saw blade extends at least partially out of the handle. However, the tool utilizes the same rotational pivot axis for both the pruning shears and the pruning saw, thus substantially increasing the length of the saw blade.

The pruning tool of an example embodiment reduces the time and effort required to prune a particular plant, tree, bush, or shrub. The user can efficiently and safely transition between the two pruning functions. Consequently, the pruning tool reduces the physical effort in the pruning process. In addition, this tool encourages the user to properly utilize the tool, thus reducing damage, disease and die back to the stem or branch being cut. The above described features and advantages, as well as others, will become more readily apparent to one of ordinary skill in the art by reference to the following detailed description and drawings.

### BRIEF DESCRIPTION OF THE DRAWINGS

The present invention may take form in various system and method components and arrangement of system and method components. The drawings are for illustrative purposes showing exemplary embodiments and are not to be construed as limiting the invention, wherein:

FIG. 1 is a right-side perspective view showing the pruning head closed and the pruning saw is in a stowed position;

FIG. 2 is a left-side perspective view showing the pruning head closed and the pruning saw is in the stowed position;

FIG. 3 is a right-side view showing the pruning head closed and the pruning saw in the stowed position;

FIG. 4 is a left-side view showing the pruning head closed and the pruning saw in the stowed position;

FIG. 5 is a right-side view showing the pruning head open and the pruning saw in the stowed position;

FIG. 6 is a left-side view showing the pruning head open and the pruning saw in the stowed position;

FIG. 7 is a right-side view showing the pruning head closed and the pruning saw in the deployed position;

FIG. 8 is a left-side view showing the pruning head closed and the pruning saw in the deployed position;

FIG. 9 is a right-side section view showing the pruning saw in the stowed position and the pruning blade lock;

FIG. 10 is a left-side section view showing the pruning saw in the stowed position and the pruning blade lock;

FIG. 11 is a left-side section view showing the pruning saw in the deployed position and the pruning blade lock; and

FIG. 12 is a left-side section view showing the pruning saw in the deployed position and an alternative pruning blade lock.

### DETAILED DESCRIPTION

The present invention will now be described more fully hereinafter with reference to the accompanying drawings, in which some, but not all embodiments of the invention are shown. Indeed, these inventions may be embodied in different forms and should not be construed as limited to the embodiments set forth herein; rather, these embodiments are provided so that this disclosure will satisfy applicable legal requirements. Like numbers refer to like elements throughout. It should be noted that while orientation-dependent terms such as upper, lower, top, etcetera are utilized, they are utilized by way of example relative to the illustrated embodiment and are not intended to be limiting, as the tool may be utilized in any of a variety of orientations other than the one shown.

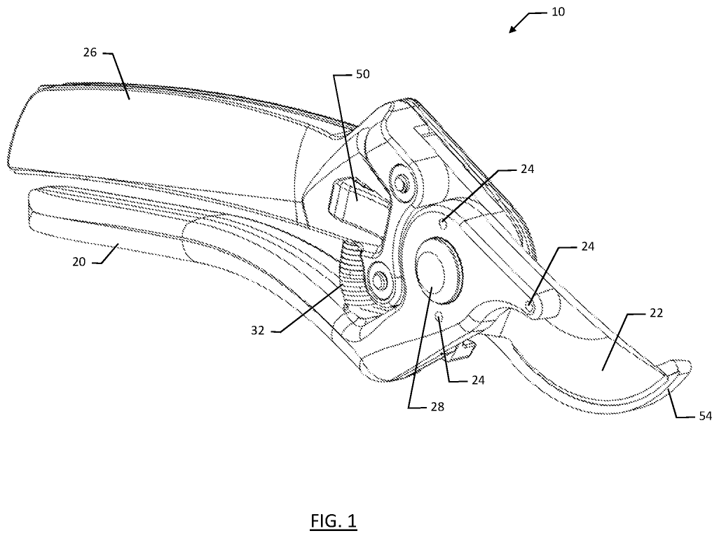

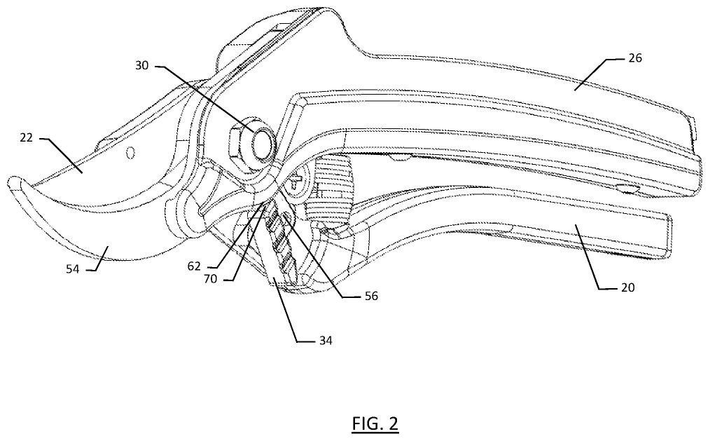

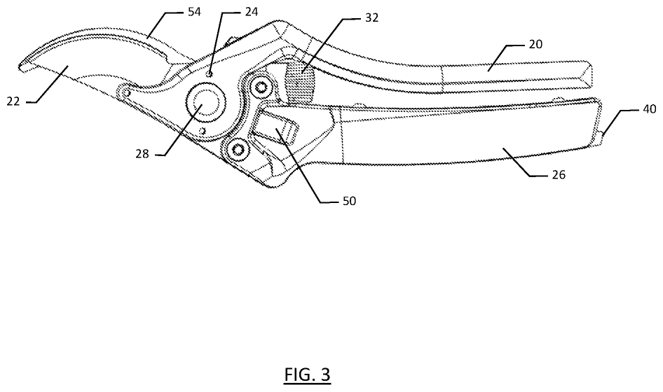

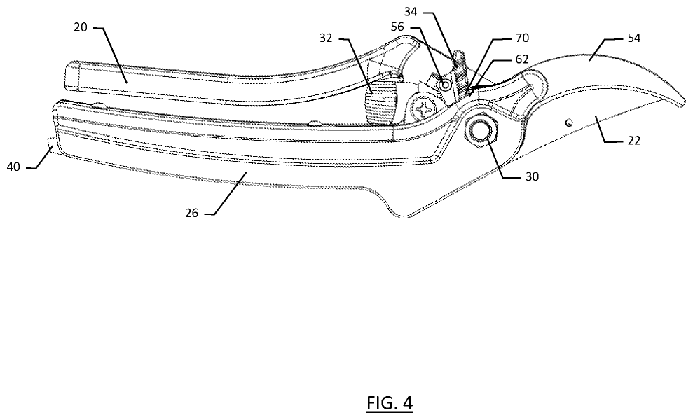

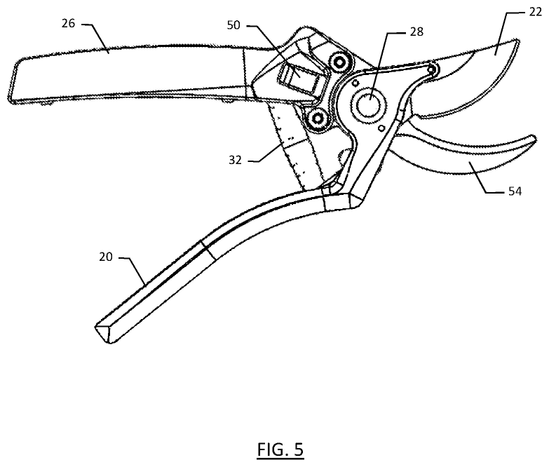

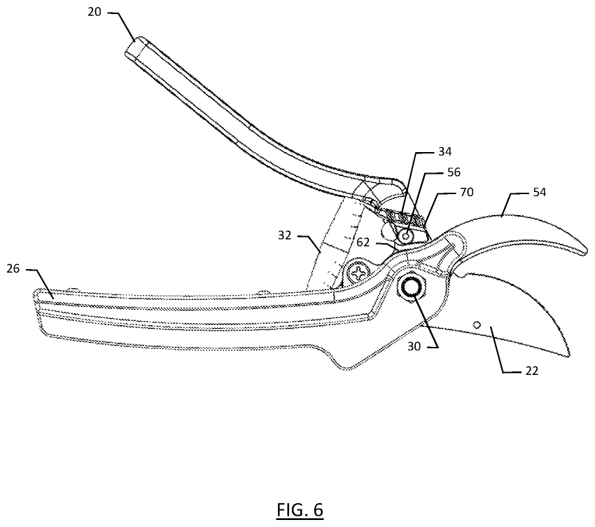

Referring now to FIGS. 1-6, a tool such as multipurpose pruner tool 10, according to an example embodiment of the present invention is depicted. While the tool will be described in the context of bypass pruning shears, other types of tools such as anvil pruners, scissors, pliers and so forth may readily employ components of embodiments of the present invention.

As shown, tool 10 of an example embodiment generally consists of a lower handle 20, a replaceable blade 22, an upper handle 26, a volute spring 32, a jaws lock 34, and a pivot joint 28. The pivot joint 28 is defined by a stud on which the replaceable blade 22, bypass blade 54, and saw blade 36 rotate. The replaceable blade 22 is detachably attached to the lower handle 20 by means of screws 24 or other suitable means, thus allowing the user to remove the replaceable blade 22 for sharpening, or for replacement with a new blade. Upper handle 26 has a bypass blade 54 built as a unitary piece in the present embodiment, but could easily be substituted by one skilled in the art to have a replaceable blade, such as an anvil blade as well. Lower handle 20 and upper handle 26 are connected by a threaded pivot joint 28 and pivot joint nut 30, which provides scissor action for the tool, defining a cutting area between the replaceable blade 22 and the bypass blade 54. Bypass blade 54 and replaceable blade 22 together form a pair of pivotally connected jaw members. Volute spring 32 is removably attached to lower handle 20 and upper handle 26 by small posts (not shown) extending from the handles in a manner that the ends of the volute spring 32 can be placed over the posts, with the volute spring 32 providing a biasing force to bias the handles toward an open position. Cutting jaws are then formed by the interaction of the replaceable blade 22 and the bypass blade 54 such that when the user squeezes the handles 20 and 26 towards each other, replacement blade 22 passes by the bypass blade 54 in a scissors motion.

A jaws lock 34 is mounted on the lower handle 20 by a pivot stud 56 which allows the jaws lock 34 to rotate around a pivot stud 56 approximately 90 degrees, from an unlocked position in which a proximal end 70 of the jaws lock 34 is not in contact with the upper handle 26 and thereby allowing the jaws to move relative to one another in a scissors action to a locked position in which the proximal end 70 of the jaws lock 34 contacts a medial section 62 of the upper handle 26, thus preventing the jaws from opening. With the jaws lock 34 in the unlocked position, the user of the tool 10 is able to place a branch or item to be cut within the open area between the replaceable blade 22 and the bypass blade 54, and by squeezing the upper handle 26 and the lower handle 20 towards each other, the replaceable blade 22 and the bypass blade 54 are then rotated around the pivot joint 28 towards each other, thus cutting the branch or item to be cut. When the user of the tool 10 has completed the desired cut or cuts, the user then squeezes the upper handle 26 and the lower handle 20 together and rotates the jaws lock 34 around the pivot stud 56 such that the distal end of the jaws lock 34 contacts a medial section 62 of the upper handle 26, preventing the jaws from opening, thus preparing the tool 10 for storage or for utilizing saw blade 36.

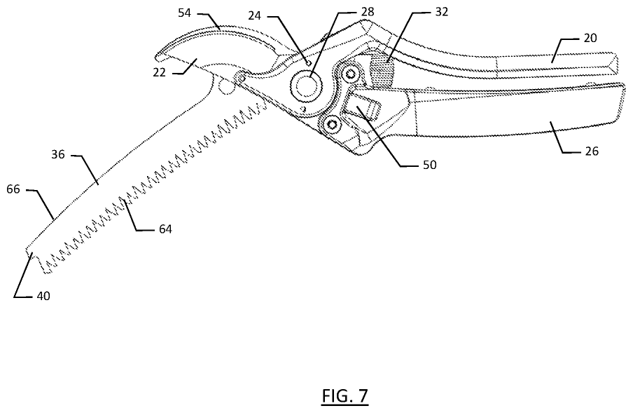

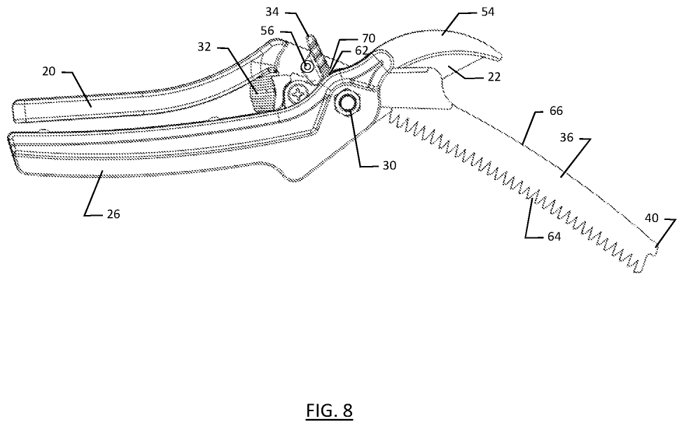

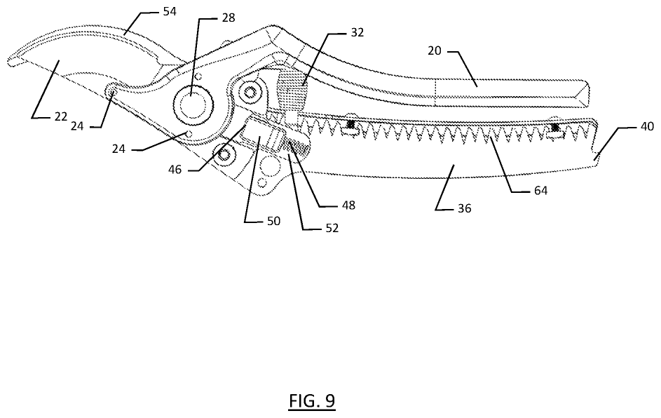

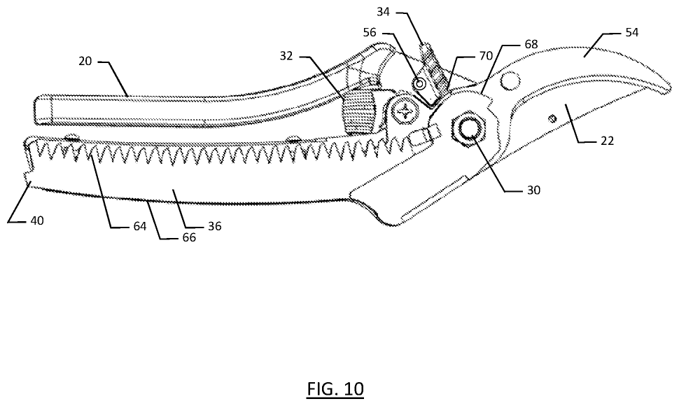

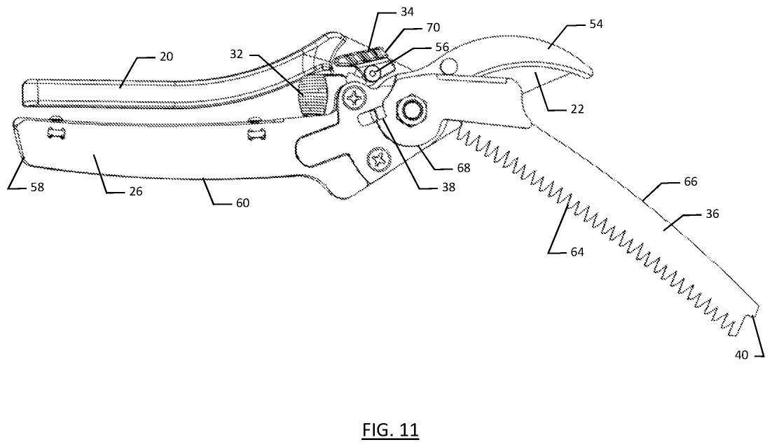

As shown in FIGS. 7-11, the upper handle 26 includes a channel (not shown) that runs substantially parallel to the longitudinal axis of the upper handle 26 along the top side 60 of upper handle 26, beginning at the distal end 58 of upper handle 26, passing through the pivot joint stud 28, and terminating at or near the bypass blade 54, the channel being suitable for housing an elongate tool, also referenced as a tool member, such as a saw blade 36, knife, or other desired tool, wherein the saw blade 36 can be in a closed position wherein the saw blade 36 is stored within the channel of the upper handle, and a deployed or open position wherein the saw blade 36 is rotated around the pivot joint stud 28 to an open and usable position in which the saw blade extends at least partially out of the handle. By having the saw blade 36 rotate around the pivot joint 28, the length of the saw blade 36 can be substantially longer than if a rotational axis were to be housed in the upper handle 36, as well as eliminates the need for an additional rotational axle, thus saving on both manufacturing costs and the complexity of the handle stowing it. The saw blade 36 contains a saw upper side 66, saw teeth 64, a deployment tab 40, a mounting hole (not shown) for mounting on the pivot joint stud 28, an arcuate locking surface 68, a lock channel 42 used for locking the saw blade 36 in an open and deployed position in which the saw blade extends at least partially out of the handle, and optionally a lock channel 44 for locking the saw blade 36 in a closed position. If lock channel 44 for locking the saw blade 36 in the closed position is not used, other mechanical options such as a pin and detent, or combining a cam surface with the arcuate locking surface 68 may be utilized to bias the saw blade 36 into a closed position.

Upper handle 26 has an elongate tool lock channel 52 running parallel to the saw blade 36 for housing an elongate tool lock 46. Elongate tool lock 46 has a lock tab 70 for interfacing with saw blade shoulder 38 such that when the saw blade 36 is deployed in the open position, the lock tab 70 engages the saw blade shoulder 38 and prevents the saw blade 36 from further rotation. When the saw blade 36 is in the closed position, the lock tab 70 rests on arcuate locking surface 68, and as the saw blade 36 is rotated from the closed position to the deployed position in which the saw blade extends at least partially out of the handle, lock tab 70 slides against arcuate locking surface 68. A coil spring 48 is provided for biasing the lock tab 70 towards the arcuate locking surface 68, and against saw blade shoulder 38 when in the deployed position. A user interface 50 is attached to elongate tool lock 46, and protrudes through a side wall of upper handle 26, thereby allowing the user to unlock the saw blade 36 from the deployed position thereby allowing the saw blade 36 to rotate back into handle 26 for safe storage.

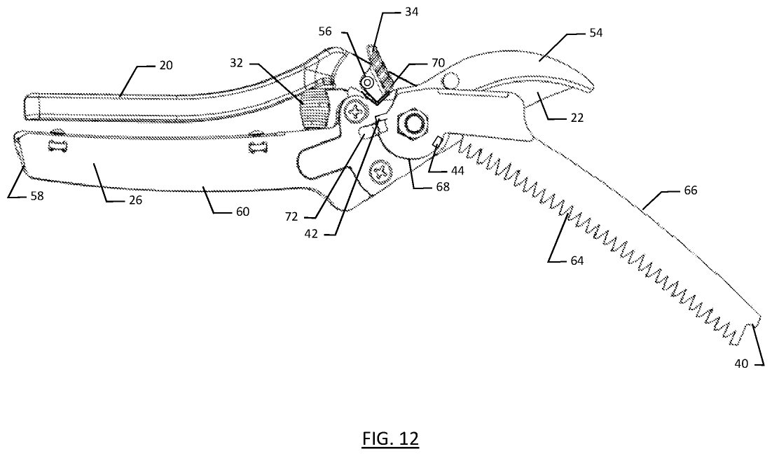

FIG. 12 depicts an alternate embodiment of locking mechanism similar to that previously described, wherein arcuate locking surface 68 has a locking channel 42 for receiving lock tab 70 thereby locking the saw blade 36 in the deployed open position in which the saw blade extends at least partially out of the handle. Optionally, a locking channel 44 for receiving lock tab 70 can be employed to lock the saw blade 36 in the closed position. If locking channel 44 is used, the user would be required to disengage lock tab 70 from channel 44 by sliding user interface 50, and thereby elongate tool lock 46 and lock tab 70 out of the channel 44 before deployment is possible.

By utilizing a pivot joint 28 and pivot joint nut 30, the user is able to take the tool 10 apart for cleaning, maintenance, and sharpening and/or replacing cutting removeable blade 22, as well as replacing the saw blade 36 with a new blade, or a different tool altogether, such as a knife blade or other tool having a desired extended length. It also allows the user to set the tightness of the pivot joint, thereby improving cutting capability of the jaws. One or more washers (not shown) may be utilized on the pivot joint 28, allowing for smoother rotation of the saw blade 36 around the pivot joint 28. Alternatively, bushings, rivets, or other mechanical means known in the art can be used for a pivot joint.

Although not shown, other implements or tools may also be housed with one or both handles of the tool, as is well known in the art, utilizing an additional channel in the handle(s) or a larger channel, and utilizing a pivot axis in the handle allowing for additional tools to be deployed.

Many modifications and other embodiments of the invention set forth herein will come to mind to one skilled in the art. Therefore, it is to be understood that the invention is not limited to the specific embodiment disclosed herein, and that modifications and other embodiments are intended to be included within the scope of the applied claims. Although specific terms are employed herein, they are used in a generic and descriptive sense only, and not for purposes of limitation.

That which is claimed is:

1. A multipurpose tool comprising:
a pair of pivotally connected jaw members;
a pair of handles attached to the jaw members, with at least one of the handles defining an elongated channel formed therein;
a pivot joint located between the jaw members and the handles, wherein the pivot joint defines a pivot axis that allows the jaw members to move in a scissors motion;
a jaws lock rotatably attached to one of the pair of handles for movement between an unlocked position allowing the jaw members to move relative to each other in a scissors motion and a locked position where the jaw members are not able to move relative to each other; and
an elongate tool pivotally connected to the pivot joint, wherein the elongate tool is moveable from a stowed position within the elongated channel of the handle to a deployed position extending at least partially out of the handle.

2. The multipurpose tool of claim 1 wherein the elongate tool is a saw blade.

3. The multipurpose tool of claim 1 wherein the elongate tool is a knife blade.

4. The multipurpose tool of claim 1 further comprising an elongate tool lock wherein the elongate tool is lockable in a deployed position at least partially out of the handle.

5. The multipurpose tool of claim 1 wherein the pivot joint comprises a threaded pivot joint stud and a pivot joint nut.

6. A multipurpose tool comprising:
a pair of pivotally connected jaw members;
a pair of handles attached to the jaw members, with at least one of the handles defining an elongated channel formed therein;
a pivot joint located between the jaw members and the handles, wherein the pivot joint defines a pivot axis that allows the jaw members to move in a scissors motion,
wherein the pivot joint comprises a threaded pivot joint stud and a pivot joint nut;
a jaws lock rotatably attached to one of the pair of handles for movement between an unlocked position allowing the jaw members to move relative to each other in the scissors motion and a locked position where the jaw members are not able to move relative to each other; and
a saw blade pivotally connected to the pivot axis, wherein the saw blade can move from a stowed position within the elongate channel of the handle to a deployed position at least partially out of the handle.

7. The multipurpose tool of claim 6 wherein the elongate tool is a saw blade.

8. The multipurpose tool of claim 6 wherein the elongate tool is a knife blade.

9. The multipurpose tool of claim 6 further comprising an elongate tool lock wherein the elongate tool is lockable in a deployed position at least partially out of the handle.

10. The multipurpose tool of claim 6 wherein the pivot joint comprises a threaded pivot joint stud and a pivot joint nut.

11. A multipurpose tool comprising:
a pair of pivotally connected jaw members;
a pair of handles attached to the jaw members, with at least one of the handles defining an elongated channel formed therein;
a pivot joint located between the jaw members and the handles, wherein the pivot joint defines a pivot axis that allows the jaw members to move in a scissors motion; and
an elongate tool pivotally connected to the pivot joint, wherein the elongate tool is moveable from a stowed position within the elongated channel of the handle to a deployed position extending at least partially out of the handle.

12. The multipurpose tool of claim 11 further comprising a jaws lock rotatably attached to one of the pair of handles for movement between an unlocked position allowing the jaw members to move relative to each other in the scissors motion and a locked position where the jaw members are not able to move relative to each other.

13. The multipurpose tool of claim 11 wherein the elongate tool is a saw blade.

14. The multipurpose tool of claim 11 wherein the elongate tool is a knife blade.

15. The multipurpose tool of claim 11 further comprising an elongate tool lock wherein the elongate tool is lockable in a deployed position at least partially out of the handle.

16. The multipurpose tool of claim 11 wherein the pivot joint comprises a threaded pivot joint stud and a pivot joint nut.
